(19) United States
(12) Patent Application Publication
(10) Pub. No.: US 2010/0175237 A1
(43) Pub. Date: Jul. 15, 2010

(54) SYSTEM FOR MOUNTING AN ABRASIVE TOOL TO A DRIVE PLATE OF GRINDING AND POLISHING MACHINES

(75) Inventors: Jacques Luk-Tung, Laval West (CA); Stephen Steinberg, Westmount (CA); Harvey Stark, Montreal (CA); Owen Rogers, North Vancouver (CA); Brian Wilson, North Vancouver (CA); Alex Chabros, Coquitlam (CA)

Correspondence Address: MARKS & CLERK, P.O. BOX 957, STATION B, OTTAWA, ON, K1P 5S7, CA

(73) Assignees: DIAMOND PRODUCTIONS CANADA LTD., Montreal (CA); WERK INDUSTRIES LTD., North Vancouver (CA)

(21) Appl. No.: 12/687,953

(22) Filed: Jan. 15, 2010

Related U.S. Application Data
(60) Provisional application No. 61/144,923, filed on Jan. 15, 2009.

(51) Int. Cl. B23P 19/04; B24B 41/00

(52) U.S. Cl. 29/243; 451/442

(57) ABSTRACT

Thus, according to one aspect, the invention provides A system for mounting an abrasive tool to a drive plate of a polisher or grinding tool, the system comprising: an intermediate element mounted to a surface of the drive plate via a first securing means; and a second securing means for securing the abrasive tool to the intermediate element. The intermediate element may be a tool mounting plate and the second securing means is at least one pin and spring assembly. The intermediate element may be a ring and the second securing element comprises magnets and pins. The intermediate element may be a circular bracket and the second securing element comprises rotary slot attachment.

### CROSS-REFERENCE TO RELATED APPLICATION

This application claims the benefit of U.S. Provisional Application No. 61/144,923 filed Jan. 15, 2009, incorporated by reference herein.

### FIELD OF THE INVENTION

The present invention relates to grinding and polishing machines. More specifically, the present invention relates to a system to change between multiple abrasive tools on grinding and polishing machines.

### BACKGROUND OF THE INVENTION

It is known in the art that grinding and polishing machines uses multiple grinding and polishing tools or abrasive tools. And quite often it is necessary to change between tools. There are very slow methods that involve bolting each of several grinding plates to one or many drive plates on grinding and polishing machines. Changing tools can take as much as 20 minutes. There are also various proprietary quick-change systems that are only available on select equipment. Many systems are difficult if not impossible to adapt generically.

Grinding and polishing machines have a drive plate on the bottom thereof. Attached thereon are the grinding and polishing tools, which is typically an abrasive material. In prior art systems, the abrasive material is typically mounted right on the drive plate, which makes it difficult to replace without replacing the drive plate as well. This reflects on cost and time consumption.

In particular, Werkmaster™ machines use multiple abrasive tools that require specific tool drive plate sizes that are unique to the Werkmaster™ machines. As there are several different models each with its own plate size this requires all the tooling to be made in each of these sizes.

### SUMMARY OF THE INVENTION

Disclosed is a system for efficiently changing the tools on the drive plate of a grinder or polishing machine. A system in accordance with the teachings of the present invention uses an intermediate element to which the tools are mounted. This arrangement is then mounted to the drive plate.

Thus, according to one aspect, the invention provides a system for mounting an abrasive tool to a drive plate of a polisher or grinding machine, the system comprising: an intermediate element mounted to a surface of the drive plate via a first securing means; and a second securing means for securing the abrasive tool to the intermediate element. The intermediate element may be a tool mounting plate and the second securing means is at least one pin and spring assembly. The intermediate element may be a ring and the second securing element comprises magnets and pins. The intermediate element may be a circular bracket and the second securing element comprises rotary slot attachment.

There are many advantages in using a quick change system in accordance with the teachings of this present invention. The uniqueness of the present invention allows for adaptation to a variety of different types of machines. The system in accordance with the teachings of this invention is at least as fast and in most cases faster than other systems for changing tools. It also provides a more stable, less complicated and more reliable functioning of the tools than most other systems. A system in accordance with the teachings of the present invention works very quickly without having complicated designs and parts. As importantly, it facilitates the use of one standard tool size for several sizes and weights of equipment making it a great deal more efficient. The cost of manufacturing is reduced because there is no need for replacing the whole head plate, but just the segments. There is also a possibility to quickly change a defective segment or even add more segments on the same plate for more aggressive work. It also provides the ability to custom balance the machine due to the irregularities of the surface being worked on.

Embodiments of the invention are specifically designed for use with Werkmaster™ grinding and polishing machines.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIGS. 1a and 1b illustrate one embodiment of a quick change system in accordance with the teachings of this invention;

FIGS. 2a, 2b and 2c illustrate a spring assembly that can be used in the quick change system of FIG. 1;

FIG. 2d illustrates a wire form spring used in the spring assembly of FIG. 2a;

FIGS. 3a, 3b 3c and 3d illustrate an assembled tool mounting plate that can be used in the quick change system of FIG. 1, showing preferable dimensions;

FIGS. 4a, 4b and 4c illustrate the tool mounting plate of FIG. 3 without pins and some preferable dimensions;

FIGS. 5a, 5b, 5c illustrate a pin that can be used in the quick change system of FIG. 1 and some preferable dimensions; and

FIG. 6a illustrates another embodiment of a quick change system in accordance with the teachings of this invention;

FIGS. 6b and 6c show possible dimensions that can be used with the embodiment of FIG. 6a;

FIG. 6d illustrates a drive plate that can be used with the embodiment of FIG. 6a;

FIG. 6e illustrates the embodiment of FIG. 6a mounted to a Werkmaster™ polisher or grinding tool;

FIG. 6f illustrates another embodiment;

FIG. 7 illustrates another embodiment of a quick change system in accordance with the teachings of this invention;

FIG. 8 illustrates an embodiment where the tool mounting plate is screwed to the drive plate; and

FIG. 9 illustrates another embodiment of a quick change system in accordance with the teachings of this invention.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

Disclosed in accordance with the teachings of this present invention is a quick change system to change the polishing or grinding tool for a polisher or grinding machine. The tool can be any suitable tool or abrasive material, such an abrasive diamond in various matrices, sandpaper, velcro-backed polishing pads, etc. A drive plate is located on the bottom of the polisher or grinding machine. Embodiments of this invention provide an efficient way to attach at least one tool to the drive plate. Embodiments of this invention use an intermediate element between the drive plate and the abrasive tool. A securing means is used to fasten the abrasive tool to the intermediate element and a second securing means is used to fasten the intermediate element to the drive plate.

In general, embodiments of the invention have been designed to work on Werkmaster™ machines. Werkmaster™ machines use multiple grinding heads that required specific tool plate sizes that are unique to the Werkmaster™ machine. As there are several different models each with its own plate size this required all the tooling to be made in each of these sizes. In order to simplify this requirement it was decided to go to a modular type tooling where one size fits all the different models and drive plate sizes. As there were height and plate size restrictions for each Werkmaster™ machine it necessitated designing a unique tool and plate assembly that would facilitate all these restrictions for each model. There are other modular type tool systems available on the market none of which could be adapted to the Werkmaster™ machines. Embodiments of the invention used on a Werkmaster™ machine reduces the need for multiple tool sizes for each model as well as greatly reducing the time required to change tools in many instances.

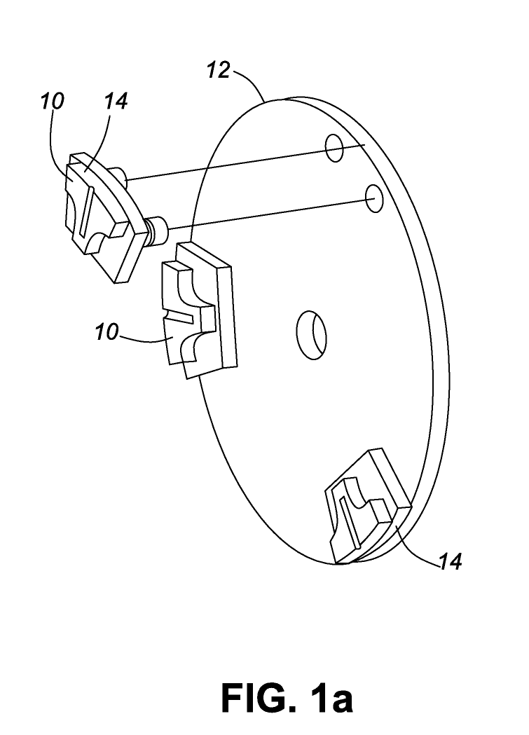

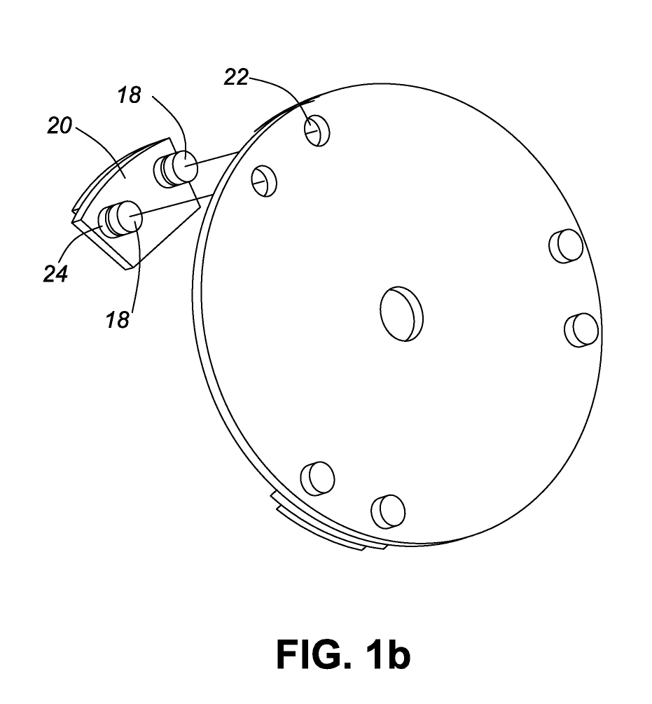

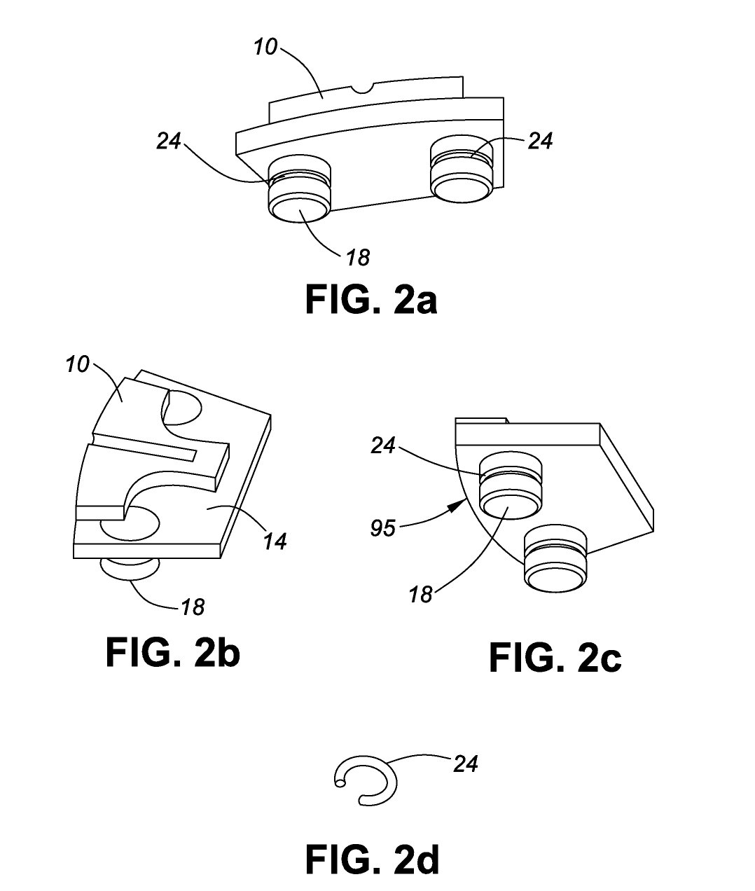

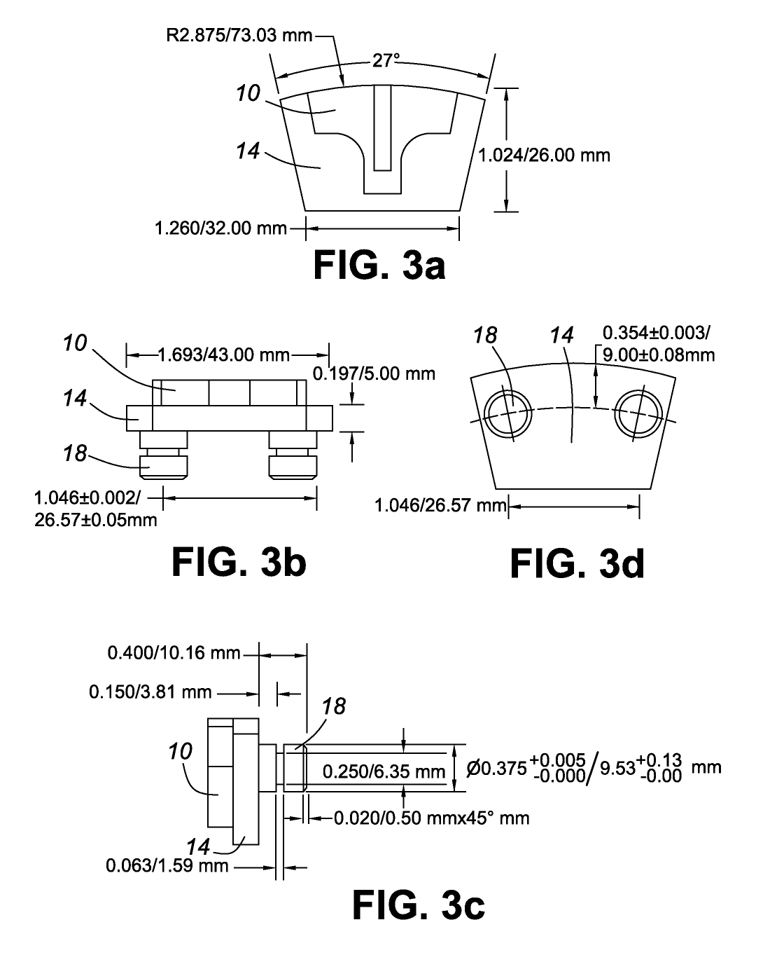

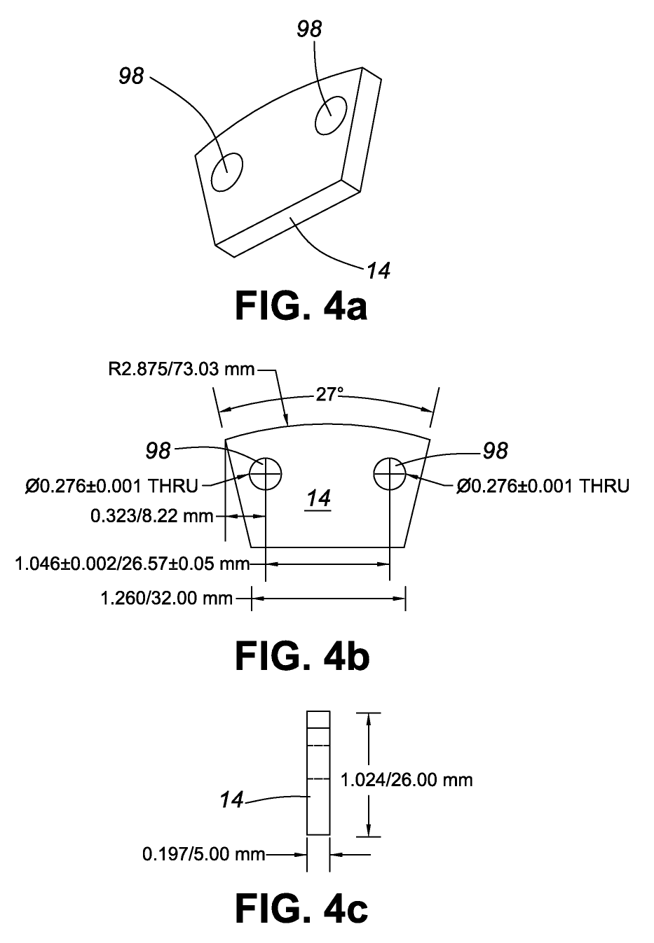

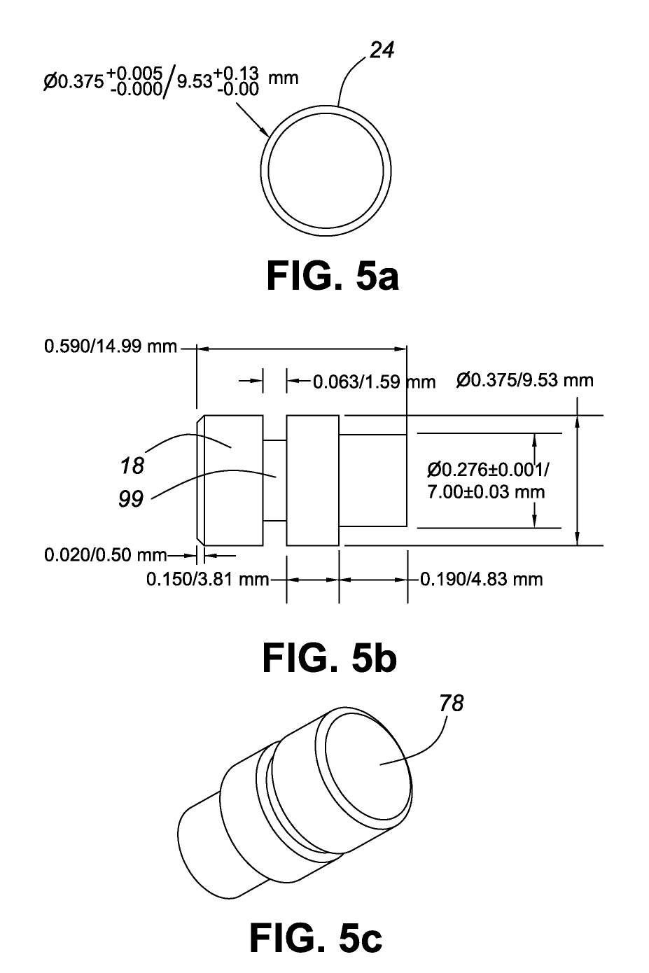

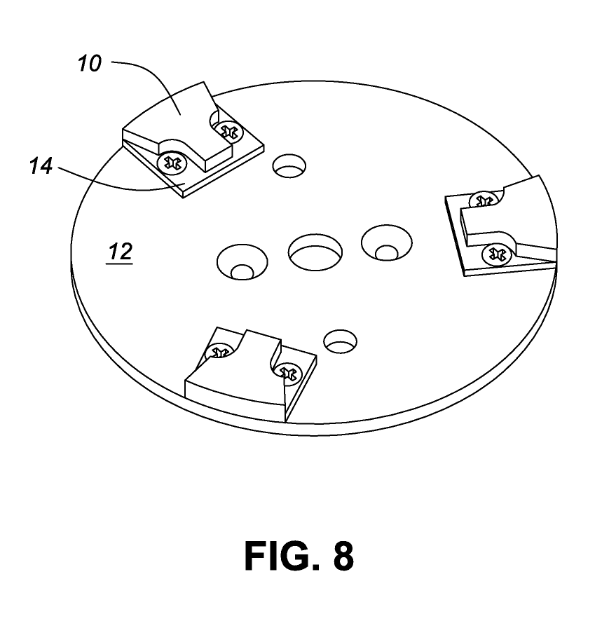

Referring to FIGS. 1 to 5, in one embodiment, the abrasive tool 10 is mounted to a tool mounting plate 14, which is mounted to the drive plate 12. The present inventors faced a problem of how to mount the tool mounting plate 14 to the drive plate 12. The present inventors tried screwing the tool mounting plate 14 to the drive plate 12, as seen in FIG. 8. However the inventors found that the time needed to replace the tool mounting plate 14 became longer.

Then the inventors tried another system using a small chamfered tail extruded from the bottom of the tool mounting plate and slides into a designated negative groove on the head using centrifugal forces keep the plate from sliding back. With this idea the time needed for replacement was shortened but the cost of manufacturing and material of the tool and the cost for the modifications of the drive plate were too high. Plus there was a risk of the tool falling since there was nothing holding it securely to the plate except the groove.

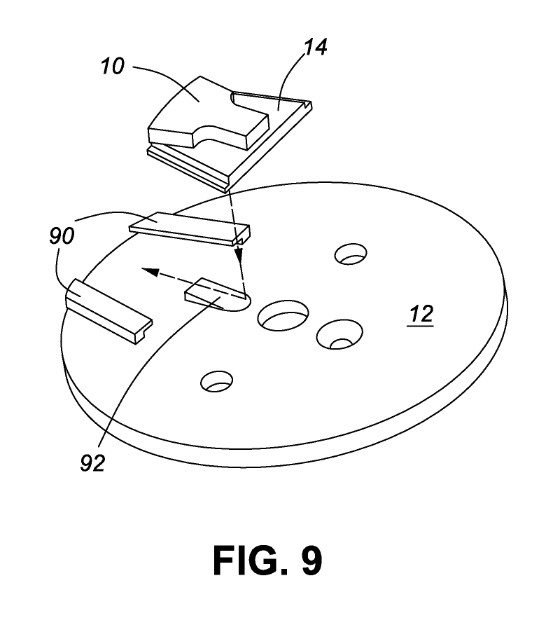

The inventors then tried using brackets 90 angled at 25° bolted to the drive plate 12 to prevent the tool mounting plate 14 with tool 10 thereon from sliding back by a small spring steel mechanism 92 (seen in FIG. 9). But the complexity of manufacture was still too great. Plus there was an issue with the removing of the tool mounting plate 14 from the drive plate 12, since it required additional tools.

The inventors then tried a drop and slide pin system. However, alignment and precision of manufacture became an issue.

The inventors then discovered a system that worked effectively and can be manufactured efficiently, as seen in FIGS. 1 to 5. Broadly, the system affixes the tool mounting plate 14 to one surface of the drive plate 12 using at least one pin and spring assembly 95. Precisely sized pins 18, made from D.O.M. steel engineered with a spring-type washer 24 made from steel affixed to a shaped tool mounting plate 14 with abrasive tool 10 secured to the surface. The spring-type washer 24 fits into groove 99 of pin 18 and allows for easy insertion and removal from a polisher or grinding machine, including a Werkmaster™ grinding or polishing machine.

Two pins 18 are welded on the back 20 of the tool mounting plate. The pins 18 drop into holes 22 in the drive plate 12 and are held by wire form springs 24. The tool mounting plate 14 is cut out of sheet metal with two holes 98 to accommodate the two pins 18. The abrasive tool 10 is welded onto the tool mounting plate 14 simultaneously with the pins 18. The pins 18 have a small groove 99 to hold the spring 24. The tool mounting plate 14 is placed on the drive plate 12 by simply pushing the pins 18 into the designated holes 98. Removing can be done by either pulling or pushing from the reverse side the tool mounting plate 14.

The mechanism does not require any additional tools for removal and replacing. It also gives the opportunity to use many combinations of segments and many configurations

Alternatives understandable by those skilled in the art include different types of pins (length, width, material) different spring-type washers, different quantity of pins, different surfaces can be used instead of abrasive material, and different sized plates to accommodate various sizes of abrasive or polishing materials.

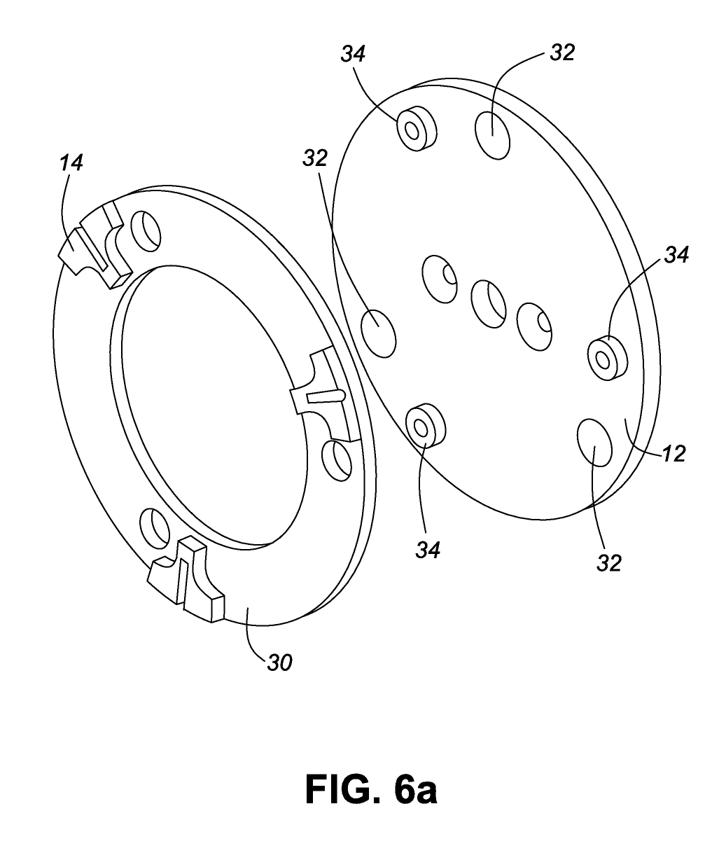

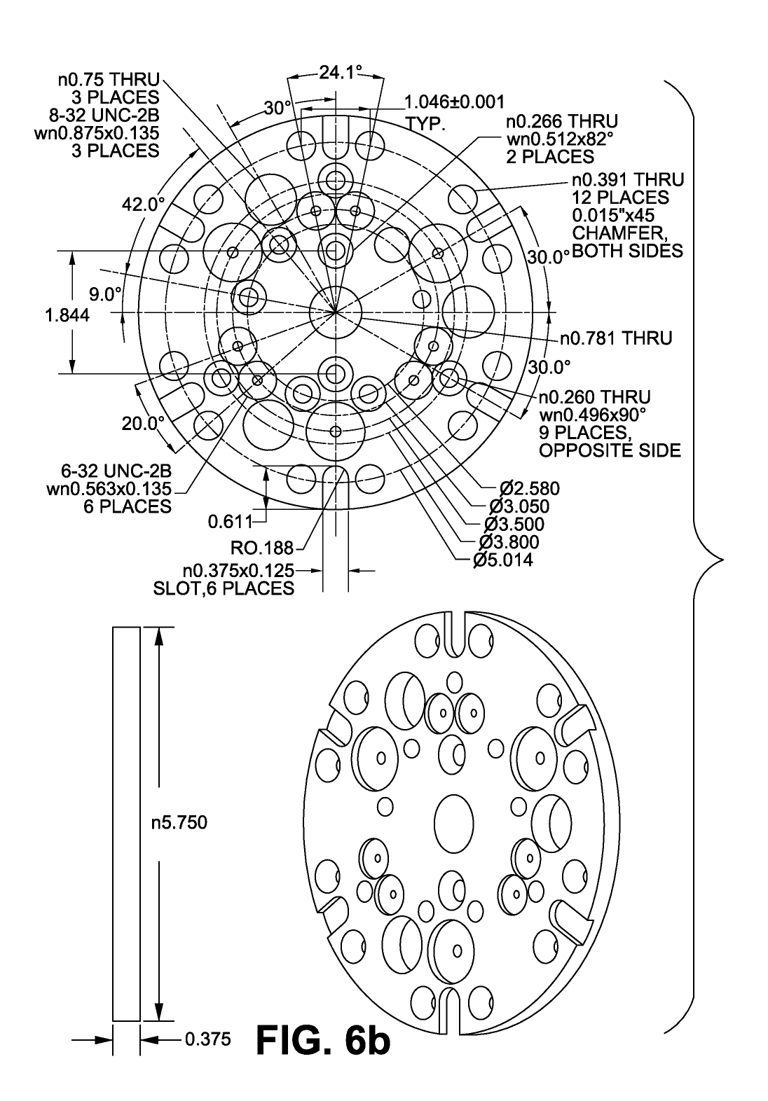

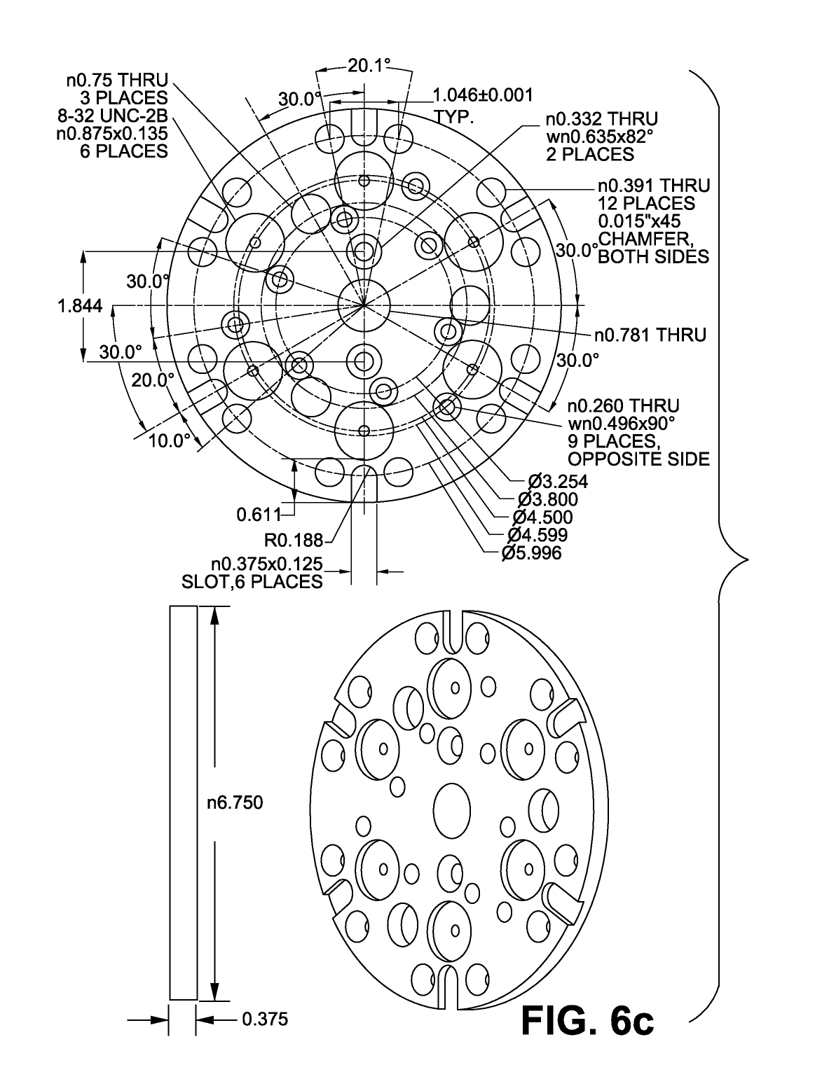

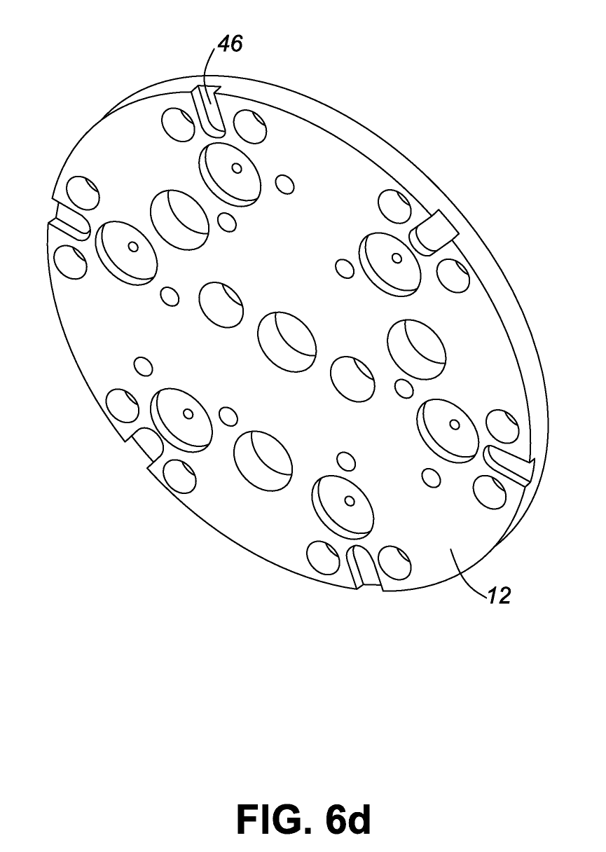

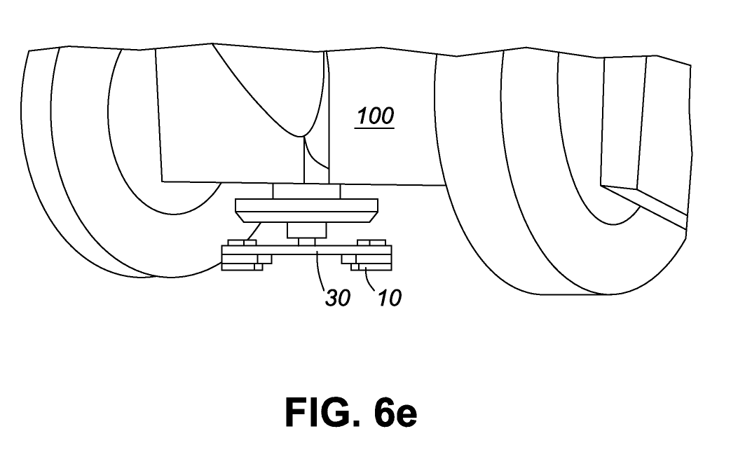

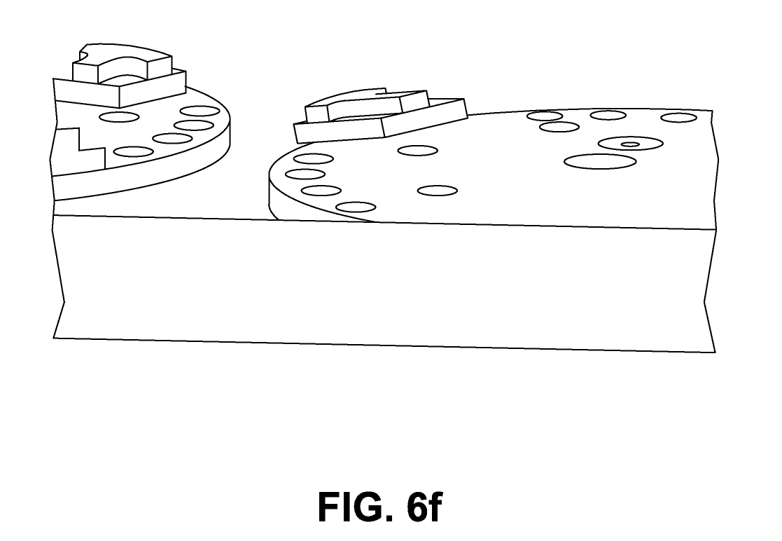

In another embodiment, referring to FIGS. 6a to 6e, the intermediate element is a ring 30 to hold the tool mounting plate 14. Magnets 32 and pins 34 are attached to the drive plate 12. The pins 34 prevent the ring 30 from moving as they are shaped and sized to fit in their respective holes 36 in the ring 30. The magnets 32 keep the ring 30 attached to the drive plate 12.

The tooling plate 30 includes high strength N40 neodymium magnets 32 that are placed in relation to where the abrasive tools 10 can be inserted. Previous designs using a ring 30 without the magnets caused the tooling segments 10 to droop and/or tilt out of their intended positions so that the tools 10 would wear irregularly and would also cause undesirable heavy tool marks. The magnets 32 are recessed into the ring 30 so that the ring 30 bears the weight of the machine 100 and the magnets 32 support the tooling segments 10 and prevent the tooling segments 10 from falling out or tilting during operation. The magnets 32 themselves have countersunk holes (not shown) in the middle to allow for them to be screwed into the plate 30. The strength of the magnets 32 is typically strong enough to make tool-less removal difficult. To address this, embodiments of the invention provide an alternative method of tooling segment extraction. In this embodiment, slots 46 are incorporated into the plate design to allow for a screwdriver to extract the tooling segment from off of the plate. A tooling segment wire form spring can be added, but the inventors have found this to be unnecessary as the magnets 32 provide enough strength to hold the tooling segments 10 in place.

FIGS. 6b and 6c show some possible dimensions of that can be used in the manufacture of ring 30. FIG. 6e illustrates this embodiment mounted to a Werkmaster™ machine.

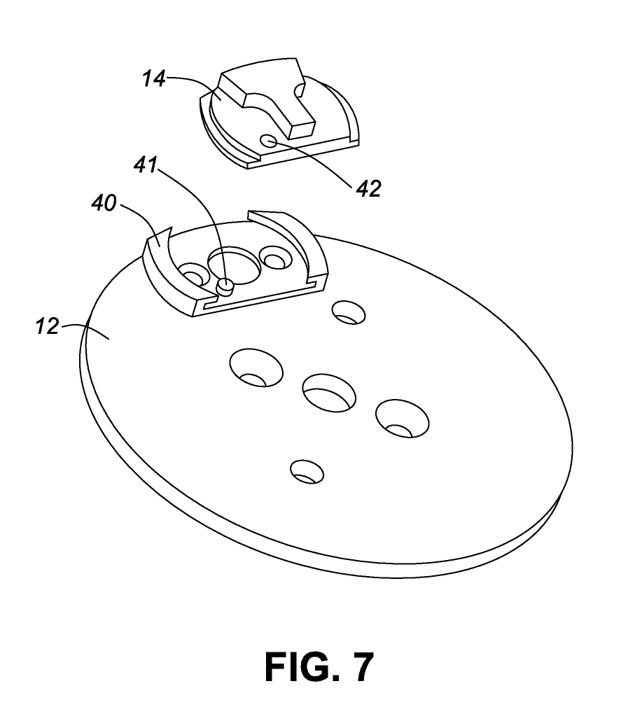

In another embodiment, referring to FIG. 7, uses a solid circular bracket 40 as the intermediate element. The bracket 40 includes a pin 41. The tool mounting plate 14 is now shaped to slide into bracket 40 and to include pin hole 42 and it is turned to snap into place. It is held by pin 41 with a spring attached to its back (not shown). The pin 41 slides into the designated hole in the tool mounting plate 14 preventing it from turning and slipping off.

Thus has been described a system for mounting an abrasive tool to a drive plate of a polisher or grinding tool. Each embodiment includes an intermediate element mounted to one surface of the drive plate and then the abrasive tool is mounted to the intermediate element. In this way, the abrasive tool can be quickly changed or replaced. The abrasive tool is securely fastened to the intermediate element, which is mounted to the drive plate in such a way that it too can be quickly changed. As mentioned above, embodiments of the invention are ideally suited for use on a Werkmaster™ machine.

The drive plate may have mounted thereon 1 or more intermediate elements as needed, and 1 or more abrasive tools may be used.

It will be appreciated that all dimensions provided are exemplary only. It will also be understood that the machine could be any suitable type of grinding or polishing machine, including machines used on the floor or machines used on countertop.

Numerous modifications may be made without departing from the spirit and scope of the invention as defined in the appended claims.

What is claimed is:

1. A system for mounting an abrasive tool to a drive plate of a grinding or polishing machine, the system comprising: an intermediate element mounted to a surface of the drive plate via a first securing means; and a second securing means for securing the abrasive tool to the intermediate element.

2. The system of claim 1, wherein the intermediate element is a tool mounting plate and the second securing means is at least one pin and spring assembly.

2. The system of claim 2, wherein the spring comprises a spring-type washer.

3. The system of claim 2, wherein the spring is made from steel.

4. The system of claim 2, wherein the plate is sized and shaped to accommodate the polisher or grinding tool.

5. The system of claim 2, wherein the abrasive material is affixed to the one surface via a hook and loop system.

6. The system of claim 1, wherein the intermediate element is a ring and the second securing element comprises magnets and pins.

7. The system of claim 1, wherein the intermediate element is a circular bracket and the second securing element comprises rotary slot attachment.

8. The system of claim 1, wherein the drive plate is sized and shaped to accommodate a Werkmaster™ grinding and polishing machine.
